(19) United States
(12) Patent Application Publication
(10) Pub. No.: US 2019/0182921 A1
(43) Pub. Date: Jun. 13, 2019

(54) Dimming controllers and dimming methods capable of receiving PWM dimming signal and DC dimming signal

(71) Applicant: Leadtrend Technology Corporation, Zhubei City (TW)

(72) Inventors: Chun Hsin Li, Zhubei City (TW); Wei Cheng Su, Zhubei City (TW); Hung Ching Lee, Zhubei City (TW); Chung-Wei Lin, Zhubei City (TW)

(21) Appl. No.: 16/199,367

(22) Filed: Nov. 26, 2018

(30) Foreign Application Priority Data
Dec. 13, 2017 (TW) 106143645

(51) Int. Cl. H05B 33/08

(52) U.S. Cl. CPC H05B 33/0845; H05B 33/0815

(57) ABSTRACT

A dimming controller is capable of receiving a dimming signal to dim light-emitting device no matter the dimming signal is of a first type or of a second type. A type identifier identifies whether the dimming signal received from an input node is of the first type or of the second type, to accordingly generate a selection signal. A signal converter generates a first signal in response to the dimming signal, and the first signal is of the first type. A multiplexer has two inputs receiving the first signal and the dimming signal respectively, and, in response to the selection signal, forwards one of the first signal and the dimming signal to a driver driving the light-emitting device.

### CROSS-REFERENCE TO RELATED APPLICATION

This application claims priority to and the benefit of Taiwan Application Series Number 106143645 filed on Dec. 13, 2017, which is incorporated by reference in its entirety.

### BACKGROUND

The present disclosure relates generally to dimming controllers and dimming methods, and, more particularly, to dimming controllers suitable of receiving a dimming signal no matter it is a pulse-width-modulation (PWM) signal or a direct-current (DC) signal.

Light emitting diode (LED), due to its characteristics in high power efficiency, compact product size, and long lifespan, has been widely adapted by lighting appliances and backlight modules. Until recently, most of cold cathode fluorescent lamps (CCFL) in the backlight modules of TV or computer display panels, for example, are replaced by LED modules.

LED modules usually need dimming controllers to perform light dimming, so as to adjust the luminance of a display panel for example. There are two different methods in the art to dim the luminance of a LED module: PWM dimming and DC dimming. PWM dimming, also named digital dimming, employs a PWM or digital signal that jumps quickly back-and-forth between levels of “0” and “1” in logic to determine the duty cycle of a LED module, the ratio of the time when the LED module emits light to the cycle time of the PWM signal. For example, when the PWM signal is “1” in logic, the luminance of the LED module is in its maximum, and when the PWM signal is “0”, it is zero, not emitting light. In other words, PWM dimming makes a LED module blinking. In contrast, DC dimming, also known as analog dimming or resistive dimming, makes a LED module emitting light continuously while the luminance of the LED module corresponds to the voltage level of a DC or analog signal.

For having more market share, a dimming controller should accommodate a dimming signal no matter the dimming signal is of PWM or of DC, and provide appropriate luminance control.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. These drawings are not necessarily drawn to scale. Likewise, the relative sizes of elements illustrated by the drawings may differ from the relative sizes depicted.

The invention can be more fully understood by the subsequent detailed description and examples with references made to the accompanying drawings, wherein:

FIG. 1 illustrates dimming controller 10 that controls the luminance of light-emitting device LT via power transistor MNDRV;

FIG. 2 demonstrates dimming controller 10a;

FIG. 3 shows the correlation between dimming signal S_{DIM}, saw-wave signal S_{SAW} and PWM signal S_{PWM};

FIG. 4 exemplifies the waveform of dimming signal S_{DIM};

FIG. 5 shows dimming methods 60a in use of dimming controller 10a in FIG. 2;

FIG. 6 demonstrates dimming controller 10b; and

FIG. 7 shows dimming methods 60b in use of dimming controller 10b in FIG. 6.

### DETAILED DESCRIPTION

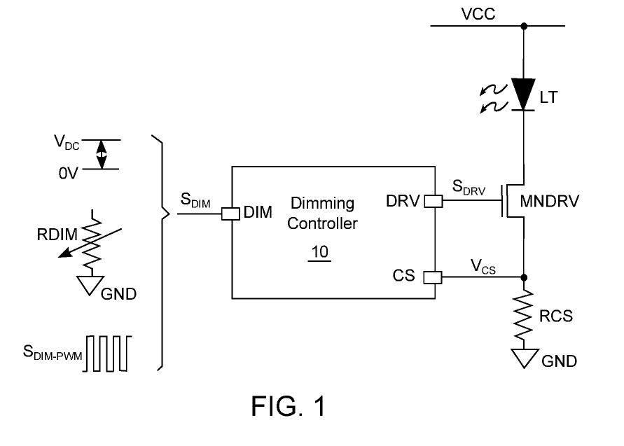

According to embodiments of the invention, FIG. 1 illustrates dimming controller 10 that controls the luminance of light-emitting device LT via power transistor MNDRV.

Power transistor MNDRV could be a NMOS transistor, acting as a current driver providing current with a proper magnitude to light-emitting device LT. Light-emitting device LT could be one or plurals of light-emitting diodes connected in series or in parallel. Dimming controller 10 provides driving signal S_{DRV} to the control gate of power transistor MNDRV. The current flowing through light-emitting device LT is monitored by dimming controller 10, as it is sensed by current-sense resistor RCS to provide current-sense signal V_{CS} at current-sense node CS. Dimming controller 10 receives dimming signal S_{DIM} from input node DIM to provide driving signal S_{DRV} accordingly.

As shown in FIG. 1, the configuration of dimming controller 10 enables three different kinds of external connection to perform dimming control. For the first one, external circuit (not shown) generates and provides DC voltage V_{DC} used as dimming signal S_{DIM} to input node DIM, and the voltage level of DC voltage V_{DC} represents the luminance of light-emitting device LT. For the second one, variable resistor RDIM connects between input node DIM and ground voltage GND, and the resistance of variable resistor RDIM is converted by dimming controller 10 into DC voltage V_{DC} representing the luminance of light-emitting device LT. How the resistance of variable resistor RDIM is converted into DC voltage V_{DC} at input node DIM will be detailed later on. For the third one, external circuit generates and provides PWM signal S_{DIM-PWM} used as dimming signal S_{DIM} to input node DIM, and the duty cycle of PWM signal S_{DIM-PWM} represents the luminance of light-emitting device LT.

In other words, dimming signal S_{DIM} could be of DC or of PWM. Dimming signal S_{DIM} could be categorized into one of two types: DC and PWM.

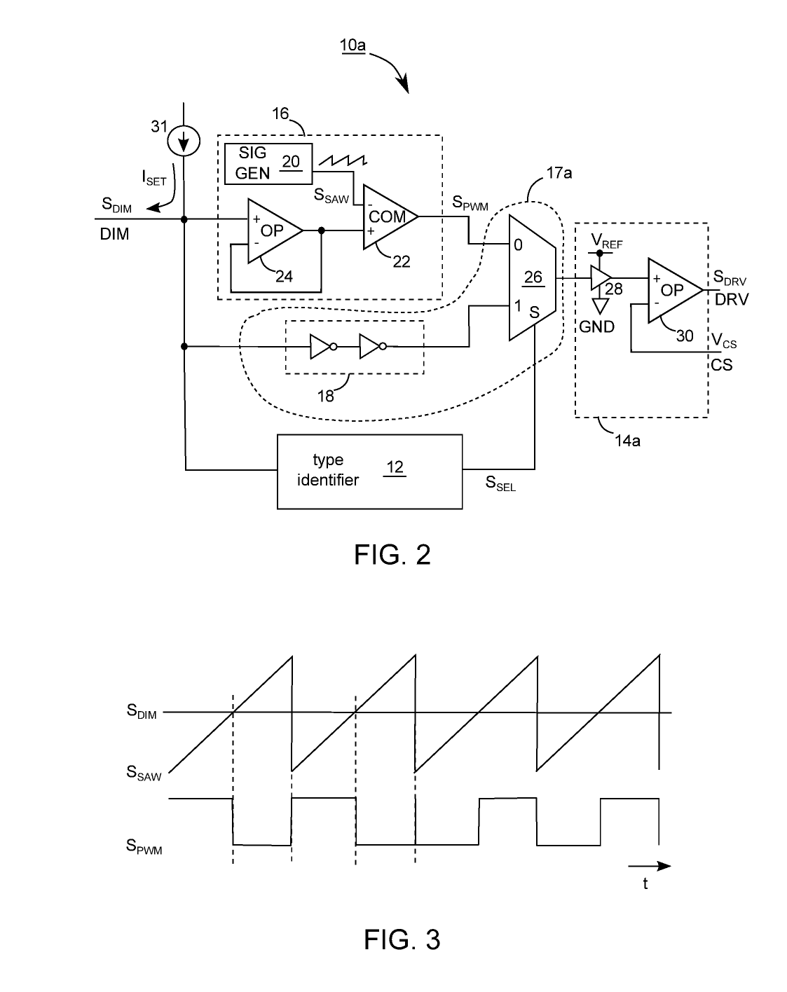

FIG. 2 demonstrates dimming controller 10a, which could be dimming controller 10 in FIG. 1 according to embodiments of the invention. Dimming controller 10a has type identifier 12, DC-to-PWM converter 16, multiplexer 17a, LED driver 14a, and constant current source 31.

DC-to-PWM converter 16 is a signal converter and, if dimming signal S_{DIM} is identified as DC, DC-to-PWM converter 16 converts dimming signal S_{DIM} into PWM signal S_{PWM}. Shown in FIG. 2, DC-to-PWM converter 16 has signal generator 20, operational amplifier 24 and comparator 22. Please refer to FIG. 3, showing the correlation between dimming signal S_{DIM}, saw-wave signal S_{SAW} and PWM signal S_{PWM}. Configured as a unity-gain buffer, operational amplifier 24 reproduces the voltage level of dimming signal S_{DIM} at the non-inverting input of comparator 22. Signal generator 20 provides the inverting input of comparator 22 saw-wave signal S_{SAW}, which, like a clock, is periodically reset to its original starting voltage. Comparator 22 compares saw-wave signal S_{SAW} with dimming signal S_{DIM} to generate PWM signal S_{PWM}. As shown in FIG. 3, PWM signal S_{PWM} is “0” in logic when saw-wave signal S_{SAW} exceeds dimming signal S_{DIM}, and “1” in logic when saw-wave signal S_{SAW} is lower than dimming signal S_{DIM}.

Type identifier 12 is connected to input node DIM, for identifying whether dimming signal S_{DIM} at input node DIM is of DC or of PWM, and accordingly provides selection signal S_{SEL}. Type identifier 12 in FIG. 2 makes selection S_{DIM} “1” in logic if it identifies dimming signal S_{DIM} as PWM, and “0” in logic if it identifies dimming signal S_{DIM} as DC.

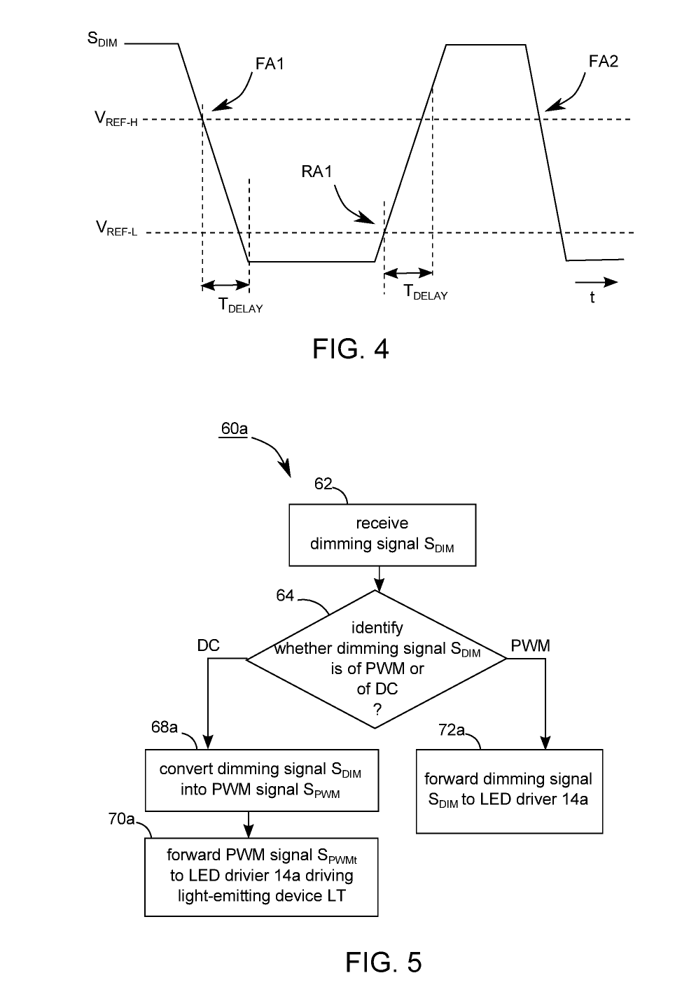

According to embodiments of the invention, selection signal S_{SEL} is determined in response to edges in dimming signal S_{DIM}. FIG. 4 exemplifies the waveform of dimming signal S_{DIM} that has two falling edges FA1 and FA2, and a rising edge RA1. Type identifier 12 provides selection signal S_{SEL} based on whether there are an enough number of significant edges within a predetermined period of time. An edge is significant to be an edge of a PWM signal when its tilt is large enough. For example, if there are more than 4 rising or falling edges found within a window of 8 ms and each of these edges has a slope whose absolute value exceeds 0.1V/us, type identifier 12 identifies dimming signal S_{DIM} as PWM, making selection signal S_{SEL} “1” in logic. Two criteria must be satisfied to make selection signal S_{SEL} “1” in logic, for example. The first one is the count of rising or falling edges in a window of 8 ms must be larger than 4. The second one is each of these edges has a slope whose absolute value exceeds 0.1V/us. In the opposite, once type identifier 12 cannot find 4 edges, each having a tilt large enough, within a window of 8 ms for example, it identifies dimming signal S_{DIM} as DC, making selection signal S_{SEL} “0” in logic.

Taking the waveform in FIG. 4 for example, type identifier 12, according to an embodiment of the invention, deems falling edge FA1 starting when dimming signal S_{DIM} goes down below reference voltage V_{REF-H} and starts a window of delay time T_{DELAY}. At the end of delay time T_{DELAY}, type identifier 12 compares dimming signal S_{DIM} with reference voltage V_{REF-L} so as to know whether the absolute slope value of falling edge FA1 exceeds (V_{REF-H}−V_{REF-L})/T_{DELAY} or not. Analogously, type identifier 12 deems rising edge RA1 starting when dimming signal S_{DIM} goes up over reference voltage V_{REF-L} and starts another window of delay time T_{DELAY}. At the end of delay time T_{DELAY}, type identifier 12 compares dimming signal S_{DIM} with reference voltage V_{REF-H} so as to know whether the absolute slope value of rising edge RA1 exceeds (V_{REF-H}−V_{REF-L}) T_{DELAY}. In another embodiment of the invention, type identifier 12 checks whether or not the falling time for dimming signal S_{DIM} going down from reference voltage V_{REF-H} to reference voltage V_{REF-L} is longer than delay time T_{DELAY}, so as to know whether a falling edge is significant enough to be a falling edge of a PWM signal. The rising time for dimming signal S_{DIM} rising from reference voltage V_{REF-L} to reference voltage V_{REF-H} is also compared with delay time T_{DELAY} to know whether a rising edge could be deemed as a rising edge of a PWM signal. If there are an enough number of edges each having an absolute slope value larger than (V_{REF-H}−V_{REF-L})/T_{DELAY}, then dimming signal S_{DIM} looks like a PWM signal, and selection signal S_{SEL} becomes “1”. Otherwise, dimming signal S_{DIM} should be a DC signal, and selection signal S_{SEL} becomes “0”.

Multiplexer 17a in FIG. 2 has digital buffer 18 and multi-input, single-output switch 26. Digital buffer 18 is a signal buffer that reproduces and provides dimming signal S_{DIM} to multi-input, single-output switch 26 if dimming signal S_{DIM} is identified as PWM. Controlled by type identifier 12, multiplexer 17a has two inputs receiving PWM signal S_{PWM} and dimming signal S_{DIM} respectively. When type identifier 12 identifies dimming signal S_{DIM} as DC, multiplexer 17a is controlled to select PWM signal S_{PWM} and forward it to LED driver 14a, while isolating dimming signal S_{DIM} from LED driver 14a. When type identifier 12 identifies dimming signal S_{DIM} as PWM, multiplexer 17a isolates PWM signal S_{PWM} from LED driver 14a, and digital buffer 18 passes dimming signal S_{DIM} on to multi-input, single-output switch 26, which, as controlled by selection signal S_{SEL}, forwards dimming signal S_{DIM} to LED driver 14a. What multiplexer 17a outputs to LED driver 14a is always a PWM signal, which is either dimming signal S_{DIM} or PWM signal S_{PWM}, where PWM signal S_{PWM} represents dimming signal S_{DIM} when dimming signal S_{DIM} is of DC.

Selection signal S_{SEL} shown in FIG. 2 controls multiplexer 17a only, but the invention is not limited to however. According to embodiments of the invention, when dimming signal S_{DIM} is identified as PWM, DC-to-PWM conversion is unnecessary, so type identifier 12 sends selection signal S_{SEL} to disenable or shut down DC-to-PWM converter 16, saving electric power. In the opposite, if dimming signal S_{DIM} is identified as DC, digital buffer 18 is optionally shut down or disenabled to save electric power.

LED driver 14a receives a PWM signal only, and controls power transistor MNDRV to regulate current flowing through light-emitting device LT in response to what multiple-input, single-output switch 26 outputs. If the output of multiple-input, single-output switch 26 is “1” in logic, level shifter 28 outputs reference voltage V_{REF}, and operational amplifier 30 makes the current through light-emitting device LT about V_{REF}/R_{CS}, where R_{CS} is the resistance of current-sense resistor RCS. If the output of multiple-input, single-output switch 26 is “0” in logic, level shifter 28 outputs 0V, and operational amplifier 30 makes the current through light-emitting device LT about 0.

Constant current source 31 provides constant current I_{SET}, which, if there is variable resistor RDIM connected between input node DIM and ground voltage GND, goes through variable resistor RDIM to generate at input node DIM DC voltage V_{DC} used as dimming signal S_{DIM}. Accordingly, constant current I_{SET} converts the resistance of variable resistor RDIM into DC voltage V_{DC}. While DC voltage V_{DC} or PWM signal S_{DIM-PWM} is directly supplied or defined from an external circuit with low output impedance, constant current I_{SET} could not affect DC voltage V_{DC} or PWM signal S_{DIM-PWM} since constant current I_{SET} is very small in magnitude.

FIG. 5 shows dimming methods 60a in use of dimming controller 10a in FIG. 2.

In step 62, dimming controller 10a receives at input node DIM dimming signal S_{DIM}, which could be a PWM signal or a DC signal.

In step 64 following step 62, type identifier 12 identifies whether dimming signal S_{DIM} is of PWM or of DC to generate selection signal S_{SEL}, which controls multiplexer 17a.

Step 68a follows step 64 if dimming signal S_{DIM} is identified as DC. DC-to-PWM converter 16 converts dimming signal S_{DIM} into PWM signal S_{PWM}.

Step 70a, in response to selection signal S_{SEL} generated in step 64, makes multiplexer 17a select PWM signal S_{PWM} and forwards it to LED driver 14a, which drives light-emitting device LT accordingly. Meanwhile, the signal path for dimming signal S_{DIM} from input node DIM, via digital buffer 18, and to LED driver 14a is disconnected. In one embodiment of the invention, step 70a disenables or shuts down digital buffer 18.

Step 72a, in response to selection signal S_{SEL} that indicates dimming signal S_{DIM} as a PWM signal, makes multiplexer 17 select dimming signal S_{DIM} and forward it via digital buffer 18 and multiple-input, single-output switch 26 to LED driver 14a driving light-emitting device LT. Meanwhile, multiplexer 17a isolates PWM signal S_{PWM} from LED driver 14a.

Dimming controller 10a in FIG. 2 and dimming method 60a in FIG. 5 have advantages as follows. If dimming signal S_{DIM} is of DC, PWM signal S_{PWM} representing dimming signal S_{DIM} is generated for LED driver 14a to drive light-emitting device LT. If dimming signal S_{DIM} is of PWM, dimming signal S_{DIM} is forwarded honestly to LED driver 14a, which faithfully and quickly responds to turn ON or OFF light-emitting device LT. No matter dimming signal S_{DIM} is a PWM signal or a DC signal, dimming controller 10a can always provide a proper PWM signal to LED driver 14a to drive light-emitting device LT appropriately.

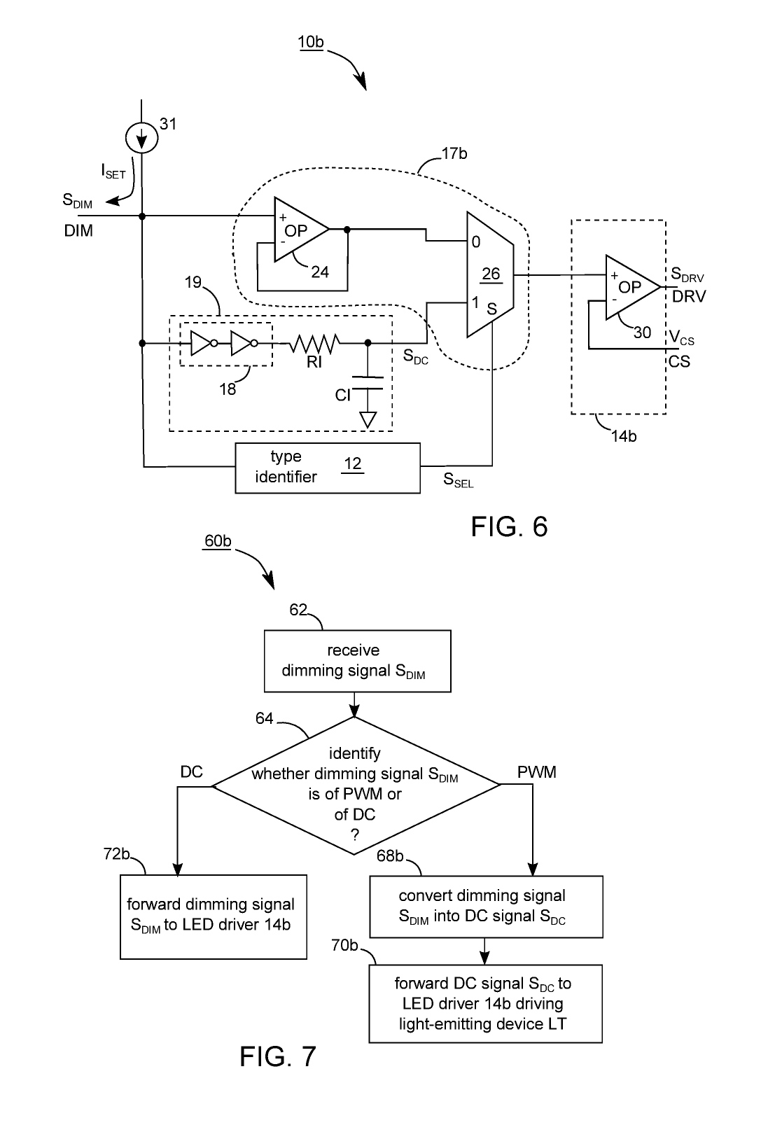

FIG. 6 demonstrates dimming controller 10b, which could be dimming controller 10 in FIG. 1 according to embodiments of the invention. Dimming controller 10b has type identifier 12, PWM-to-DC converter 19, multiplexer 17b, LED driver 14b, and constant current source 31. Several devices or circuits in FIG. 6 have been disclosed or taught by FIG. 2 and the relevant paragraphs, and their function and operation are not repeatedly detailed for brevity.

PWM-to-DC converter 19 is a signal converter and, if dimming signal S_{DIM} is of PWM, it is capable of converting dimming signal S_{DIM} into DC signal S_{DC}. Shown in FIG. 6, PWM-to-DC converter 19 has digital buffer 18, resistor R1 and capacitor C1. Digital buffer 18 reproduces the logic value of dimming signal S_{DIM} and provides it to resistor R1. Resistor R1 and capacitor C1 together form a low-pass filter, capable of generating DC signal S_{DC} whose voltage level represents the duty cycle of dimming signal S_{DIM}.

Multiplexer 17b in FIG. 6, controlled by type identifier 12, has two inputs receiving DC signal S_{DC} and dimming signal S_{DIM} respectively. Multiplexer 17b has operational amplifier 24 and multiple-input, single-output switch 26. When type identifier 12 identifies dimming signal S_{DIM} as DC, operational amplifier 24, acting as a unity-gain buffer and a signal buffer, reproduces dimming signal S_{DIM} at its output and forwards dimming signal S_{DIM} to multiple-input, single-output switch 26, which continuously forwards dimming signal S_{DIM} to LED driver 14b, but blocks DC signal S_{DC} from reaching LED driver 14b. When type identifier 12 identifies dimming signal S_{DIM} as PWM, multi-input, single-output switch 26 in FIG. 6, as controlled by selection signal S_{SEL}, forwards DC signal S_{DC} to LED driver 14b and blocks dimming signal S_{DIM} from reaching LED driver 14b. What multiplexer 17b outputs to LED driver 14a is always a DC signal, which is either dimming signal S_{DIM} or DC signal S_{DC}, where DC signal S_{DC} represents dimming signal S_{DIM} if dimming signal S_{DIM} is of PWM.

LED driver 14b receives a DC signal only, and controls power transistor MNDRV to regulate current flowing through light-emitting device LT in response to what multiple-input, single-output switch 26 outputs. If the output of multiple-input, single-output switch 26 has voltage level V_{OUT} operational amplifier 30 makes the current through light-emitting device LT about V_{OUT}/R_{CS}.

FIG. 7 shows dimming methods 60b in use of dimming controller 10b in FIG. 6. Some steps in FIG. 7 are the same or similar with steps in FIG. 5, so they are not repeatedly detailed here since they are comprehensible in view of related disclosure in the previous paragraphs.

Step 72b, in response to selection signal S_{SEL} that indicates dimming signal S_{DIM} as a DC signal, makes multiplexer 17b select dimming signal S_{DIM} and forward it via multiple-input, single-output switch 26 to LED driver 14b driving light-emitting device LT. Meanwhile, selection signal S_{SEL} causes multiplexer 17b to isolate DC signal S_{DC} from LED driver 14b.

Step 68b follows step 64 if dimming signal S_{DIM} is identified as PWM. PWM-to-DC converter 19 converts dimming signal S_{DIM} into DC signal S_{DC}.

Step 70b, in response to selection signal S_{SEL} generated in step 64, follows step 68b. Step 70b makes multiplexer 17b select DC signal S_{DC} and forward it to LED driver 14b, which drives light-emitting device LT accordingly. Meanwhile, the signal path for dimming signal S_{DIM} from input node DIM, via operational amplifier 24, and to LED driver 14b is interrupted.

Selection signal S_{SEL} shown in FIG. 6 controls multiple-input, single-output switch 26 only, but the invention is not limited to however. According to embodiments of the invention, if dimming signal S_{DIM} is identified as PWM, operational amplifier 24 is optionally shut down or disenabled to save electric power. Similarly, when dimming signal S_{DIM} is identified as DC, type identifier 12 sends selection signal S_{SEL} to disenable or shut down digital buffer 18, saving electric power.

Dimming controller 10b in FIG. 6 and dimming method 60b in FIG. 7 have advantages as follows. If dimming signal S_{DIM} is of DC, dimming signal S_{DIM} is forwarded honestly to LED driver 14b, which faithfully and analogically adjusts the current through light-emitting device LT. The current through light-emitting device LT is V_{OUT}/R_{CS} if the voltage level of dimming signal S_{DIM} is V_{OUT}. While dimming signal S_{DIM} is identified as PWM, DC signal S_{DC}, representing the duty cycle of dimming signal S_{DIM}, is generated and forwarded to LED driver 14b to drive light-emitting device LT. No matter dimming signal S_{DIM} is a PWM signal or a DC signal, dimming controller 10b can always provide a proper DC signal to LED driver 14b to drive light-emitting device LT appropriately.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A dimming controller for dimming a light-emitting device, comprising:
an input node for receiving a dimming signal;
a type identifier connected to the input node, for identifying whether the dimming signal is of a first type or a second type;
a signal converter connected to the input node, for generating a first signal in response to the dimming signal, wherein the first signal is of the first type; and
a multiplexer controlled by the type identifier, having two inputs receiving the first signal and the dimming signal respectively, wherein the type identifier makes the multiplexer forward the first signal to a driver driving the light-emitting device if the dimming signal is identified as the second type, and the dimming signal to the drive if the dimming signal is identified as the first type.

2. The dimming controller as claimed in claim 1, wherein the first type is one of direct-current and pulse-width-modulation, and the second type is the other.

3. The dimming controller as claimed in claim 1, wherein the first type is pulse-width-modulation, the second type is direct-current, and the signal converter is a DC-to-PWM converter.

4. The dimming controller as claimed in claim 1, wherein in response to an edge of the dimming signal the type identifier provides a selection signal to the multiplexer.

5. The dimming controller as claimed in claim 4, wherein the dimming signal comprises edges in a predetermined period of time, and the type identifier provides the selection signal in response to whether each of the edges has a slope whose absolute value is larger than a predetermined value.

6. The dimming controller as claimed in claim 1, further comprising:
a constant current source for providing a constant current flowing through the input node.

7. The dimming controller as claimed in claim 1, wherein the type identifier disenables the signal converter if the dimming signal is identified as the first type.

8. The dimming controller as claimed in claim 1, wherein the multiplexer comprises:
a signal buffer; and
a multiple-input, single output switch controlled by the type identifier;
wherein the signal buffer reproduces the dimming signal and provides the dimming signal to the multiple-input, single output switch.

9. The dimming controller as claimed in claim 8, wherein the type identifier disenables the signal buffer if the dimming signal is identified as the second type.

10. A dimming method for a light-emitting device, comprising:
receiving a dimming signal;
identifying whether the dimming signal is of a first type or a second type to provide a selection signal;
converting the dimming signal to provide a first signal of the first type; and
forwarding one of the first signal and dimming signal in response to the selection signal to a driver driving the light-emitting device.

11. The dimming method as claimed in claim 10, comprising:
providing the selection signal in response to an edge of the dimming signal.

12. The dimming method as claimed in claim 11, wherein the dimming signal comprises edges in a predetermined period of time, and the dimming method comprises:
providing the selection signal in response to whether each of the edges has a slope whose absolute value is larger than a predetermined value.

13. The dimming method as claimed in claim 12, comprising:
providing the selection signal in response to whether a count of the edges is more than a certain number.

14. The dimming method as claimed in claim 10, wherein the first type is one of pulse-width-modulation and direct-current, and the second type is the other.

15. The dimming method as claimed in claim 10, wherein a signal converter converts the dimming signal to provide the first signal, and the dimming method comprises:
disenabling the signal converter if the selection signal indicates the dimming signal is of the first type.
